(19) United States
(12) Patent Application Publication
(10) Pub. No.: US 2012/0050335 A1
(43) Pub. Date: Mar. 1, 2012

(54) ZOOMING SYSTEM FOR A DISPLAY

(75) Inventor: Chih-Sheng HOU, Taipei (TW)

(73) Assignee: UNIVERSAL CEMENT CORPORATION, Taipei (TW)

(21) Appl. No.: 12/868,599

(22) Filed: Aug. 25, 2010

(51) Int. Cl. G09G 5/00

(52) U.S. Cl. 345/661

(57) ABSTRACT

A zooming pressure sensor is used to control the zooming of information in a zooming frame on a displayed for a cell phone, portable media device, or an electronic reader. A zooming pressure sensor converts finger pressure into corresponding physical parameter such as conductance, resistance, or charge, which is further processed by a circuit for control parameter of a zooming frame. The magnitude of output parameters is designed in positive relation to zoom-in, and in negative relation to zoom-out.

### BACKGROUND

1. Technical Field

The present invention relates to a zooming system for zooming information in a zooming frame for a display used in a cell phone, portable media device, or an electronic reader.

2. Description of Related Art

FIG. 1 is a conventional zooming system.

A traditional zooming system for zooming the information in a zooming frame on a cell phone display uses a pinch-to-zoom control system as can be seen in FIG. 1. It disclosed that an index finger and a thumb are used to touch a screen of the display for controlling the zoom-in and zoom-out for information on the display. For a larger display, both hands are used to replace the index finger and thumb for zooming operation. Referring to FIG. 1, the information is zooming in when the two points are moving close to each other, and the information is zooming out when the two points are moving away from each other. Although it is a practical operation for zooming operation, not all users can freely or easily operate this function with his two fingers or two hands, especially someone handicapped in hand. Further, once a new zoom level is set, the traditional technique does not allow straightforward backtracking to original screen position and zoom level. Therefore, a different design choice is desirable to submit for different user's convenience.

### BRIEF DESCRIPTION OF THE DRAWINGS

FIG. 1 is a conventional zooming system.

FIG. 2 is a structure for a piezoresistive sensor.

FIG. 3 is an output conductance v. pressure for the piezoresistive sensor of FIG. 2.

FIG. 4 is a first logic for zoom-in correlated with pressure according to the present invention.

FIG. 5 is a second logic for zoom-out correlated with pressure according to the present invention.

FIG. 6 is a logic circuit for the present invention.

FIG. 7 is an algorithm for creating a zooming frame according to the present invention.

FIG. 8 is an algorithm for updating the zooming frame according to the present invention.

FIG. 9-11 shows zoom-out for a selected area according to the present invention.

FIG. 12-14 shows zoom-in for a selected area according to the present invention.

FIG. 15 is a virtual closing box for closing zoom-mode according to the present invention.

FIG. 16 is a first method for closing zoom-mode without using an independent button according to the present invention.

FIG. 17 is a second method for closing zoom-mode according to the present invention.

FIG. 18 is a modified pressure sensor according to the present invention.

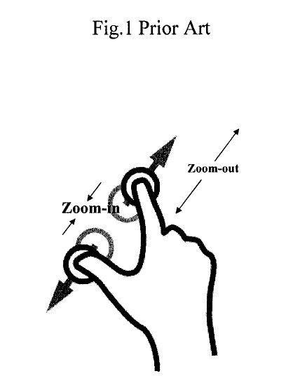

### DETAILED DESCRIPTION OF THE INVENTION

A zooming pressure sensor is used to control zooming function of information in a zooming frame on a display. The zooming pressure sensor senses a pressure applied thereon and triggers a circuitry to convert a corresponding physical parameter such as conductance, capacitance, or charge into output information to be referred by a zooming frame. The magnitude of output parameters is designed, e.g. in positive relation with reference to zoom-in function and in negative relation with reference to zoom-out function. A piezoresistive sensor is illustrated hereinafter, however, depends on design choices, a capacitance-type pressure sensor, a strain gauge, or a piezoelectric sensors can also be designed in to replace the piezoresistive sensor. A strain gauge also responds to pressure with a change in conductance.

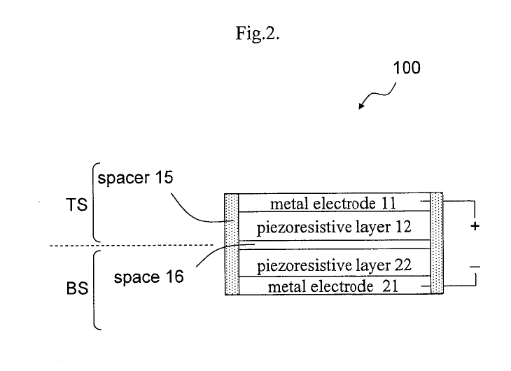

FIG. 2 is a structure for a piezoresistive sensor.

A typical piezoresistive sensor is made of a top stack (TS) and a bottom stack (BS). The two stacks TS, BS are stacked with a space 16 in between them, spacers 15 are required to support the two stacks TS, BS and to maintain the presence of the space 16 in between. The structure of the top stack TS includes a top metal electrode 11 and a piezoresistive layer 12 configured under the top metal electrode 11. The structure of the bottom stack BS includes a bottom metal electrode 21 and a piezoresistive layer 22 configured on the top of the bottom metal electrode 21.

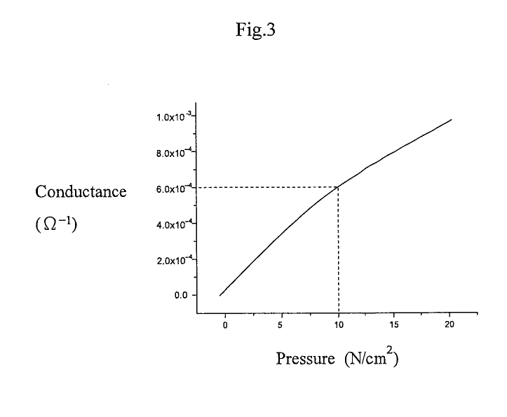

FIG. 3 is an output conductance v. pressure for the piezoresistive sensor of FIG. 2.

An output resistance (R) for the pressure sensor 100 follows ohm's law as follows:

R=ρL/A.

Since the opposite of resistance (R) is conductance (G), i.e., G=1/R and therefore, the formula becomes: G=A/ρL.

wherein, L is the total thickness of the touched piezoresistive layers 12, 22; A is the contact area of the piezoresistive layers.

Either resistance (R) or conductance (G) can be chosen to express the relationship between it and the pressure sensed in the piezoresistive sensor 100. Conductance is chosen to express in FIG. 3 with reference to the pressure applied on the piezoresistive sensor 100. The unit of Ohm (Ω) is used for resistance, while the unit of Mho (Ω⁻¹) is used for conductance. The unit of Newton per square centimeter (N/cm²) is used for pressure applied on the piezoresistive sensor 100.

A linear relationship is shown in FIG. 3 for conductance (Ω⁻¹) output versus pressure (N/cm²) applied. For example, when the pressure is at 10 N/cm², the output conductance is 6.0*10⁻⁴ (Ω⁻¹). The magnitude of the output conductance is designed in the circuitry to correlate to the magnitude of the zoom factors according to the present invention.

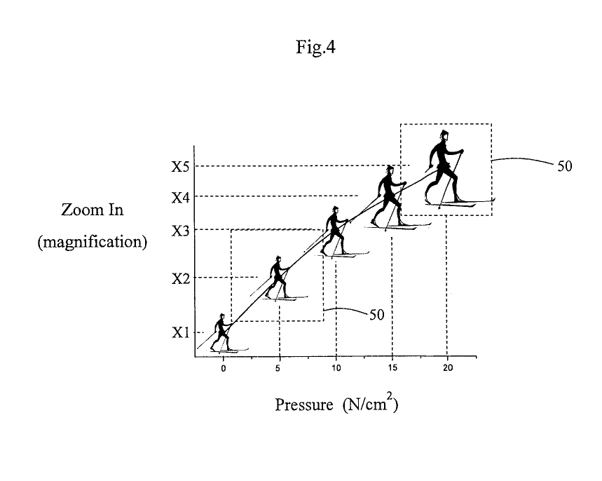

FIG. 4 is a first logic for zoom-in correlated with pressure according to the present invention.

A positive relation between the zoom factors and the pressure applied to the piezoresistive sensor 100 is illustrated in FIG. 4. The Y-axis shows zoom level and the X-axis shows pressure. The information within a zooming frame changes with different zoom-level.

The skiing figure is expanded by a factor of three (X3) at 10 N/cm² with reference to the original size (X1) of the skiing figure at 0 N/cm². The skiing figure is expanded by a factor of five (X5) at 20 N/cm² with reference to the original size (X1) of the skiing figure at 0 N/cm². The screen size of a display is fixed and now herein expressed with dotted square 50 for a reference to compare with the size of the expanded skiing figure.

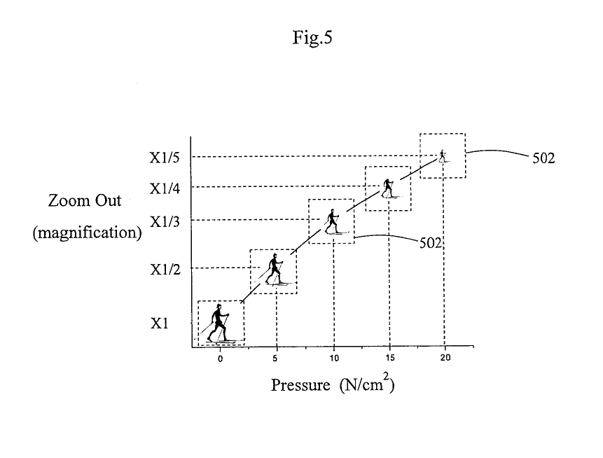

FIG. 5 is a second logic for zoom-out correlated with pressure according to the present invention.

A negative relation between the zoom factors and the pressure applied to the piezoresistive sensor 100 is illustrated in FIG. 5.

The skiing figure is shrunk by a factor of one-third (X1/3) at 10 N/cm² with reference to the original size (X1) of the skiing figure at 0 N/cm². The skiing figure is shrunk by a factor of one-fifth (X1/5) with reference to the original size (X1) of the skiing figure at 0 N/cm². The screen size of a display is fixed and now herein expressed with dotted square 502 for a reference to compare with the size of the shrunk skiing figure.

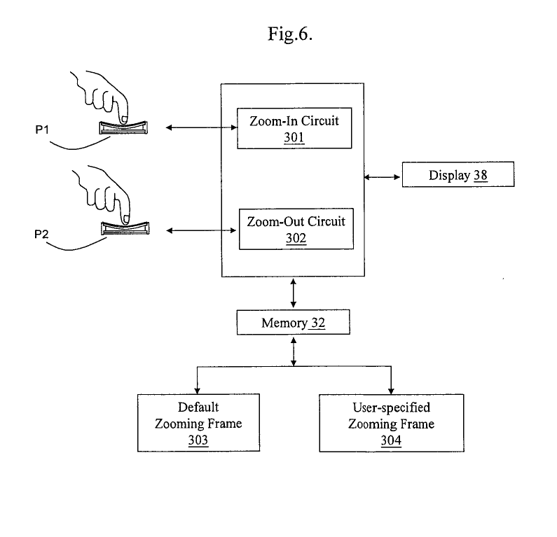

FIG. 6 is a logic circuit for the present invention.

A first pressure sensor P1 is electrically coupled to a zoom-in circuit 301, and a second pressure sensor P2 is electrically coupled to a zoom-out circuit 302. A display 38 is electrically coupled to the logic circuits 301, 302 for displaying. A memory 32 is electrically coupled to the logic circuits 301, 302, as storage for the information to be zoomed. The information in a zooming frame to be stored in the memory 32 can be either a default zooming frame 303 which is usually full page information or a user-specified zooming frame 304 which is usually partial information of the full page information to be selected.

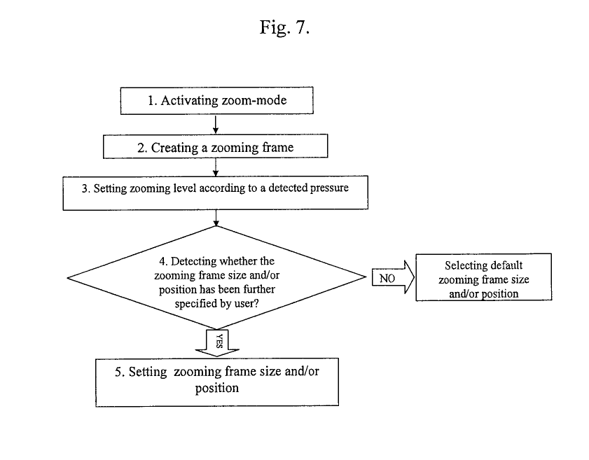

FIG. 7 is an algorithm for creating a zooming frame according to the present invention. The steps for creating a zooming frame includes:

(1) Activating zoom-mode, by pushing a zoom-mode button;

(2) Creating a zooming frame;

(3) Setting zooming level according to a detected pressure;

(4) Detecting whether the zooming frame size and/or position has been further specified by user?

if yes go next step,
if no, selecting default zooming frame size and/or position;

(5) Setting zooming frame size and/or position.

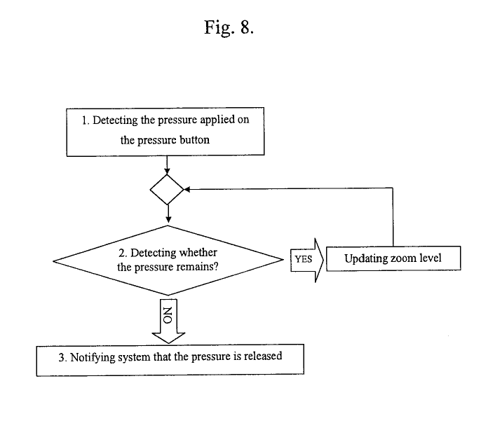

FIG. 8 is an algorithm for updating the zooming frame according to the present invention.

While the pressure button is pressed and before released, the system shall update zoom level for the information in the zooming frame; once user stops pressing the pressure button, the system shall be notified to go next step. The algorithm includes:

(1) Detecting the pressure applied on the pressure button;

(2) Detecting whether the pressure remains?

if yes, updating zoom level and/or other information such as zoom frame size and/or position;
if no, go next step

(3) Notifying system that the pressure is released.

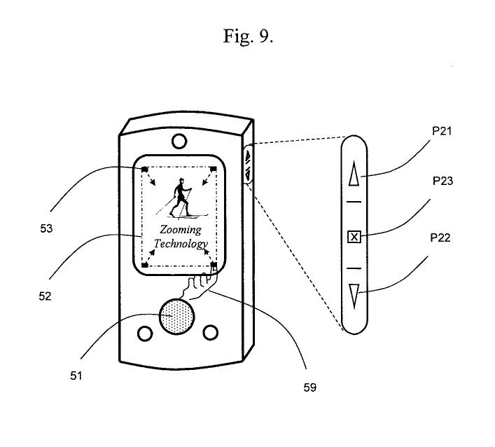

FIG. 9-11 shows zoom-out for a selected area according to the present invention.

FIG. 9 shows a cell phone has a zoom-mode button 51 configured in front surface, and a zoom-in button P21, a zoom-out button P22, and a closing button P23 in between the two buttons P21, P22, are configured on a lateral side of the cell phone. The button can also be mounted either on the front side or back side of the cell phone.

A first zooming pressure sensor (not shown) similar to the pressure sensor 100 is configured under the zoom-in button P21, the zoom-in button P21 can be pressed to trigger the zoom-in function. A second zooming pressure sensor (not shown) similar to the pressure sensor 100 is configured under the zoom-out button P22. The zoom-out button P22 can be pressed to trigger the zoom-out function.

When a zoom-mode button 51 is activated, a default zooming frame 52 appears on the display, which delimits full page information to be zoomed before it has been further specified by user. Four adjusting blocks 53 are displayed on each of the four corners of the zooming frame for the user to adjust the size to be zoomed through a finger of a hand 59. The information to be zoomed within the zooming frame 52 is then stored in the memory 32 waiting to be processed. The zooming frame can be moved to a different position by dragging one of the four frame lines of the zooming frame.

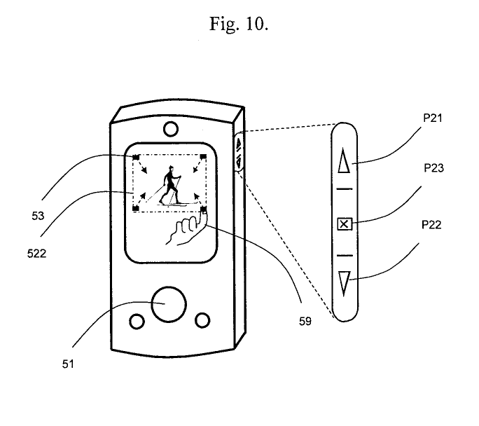

FIG. 10 shows only the skiing figure is delimited as the information to be zoomed. The information within the zooming frame 522 is then stored in the memory 32.

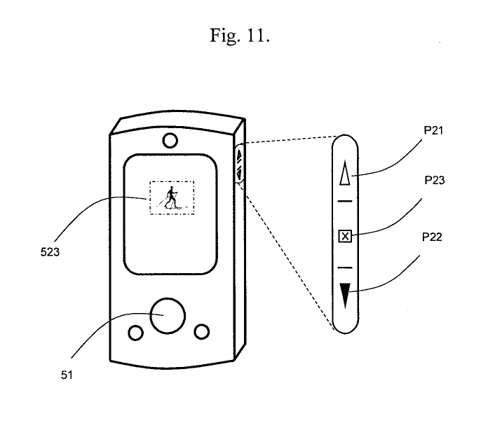

FIG. 11 shows zoom-out according to the present invention.

After the zooming frame 522 is determined in FIG. 10, zoom-out button P22 is pressed, the information in the zooming frame 522 is shrunk, in proportion to the pressure applied, into a smaller one as shown in FIG. 11, the shrunk information within the zooming frame 523. The skiing figure of FIG. 11 is shrunk to a smaller one with reference to the skiing figure in FIG. 10.

A physical closing box P23 is configured in between the zoom-in button P21 and the zoom-out button P22 for closing zoom-mode. The physical closing box P23 can be pressed to close the zoom-mode.

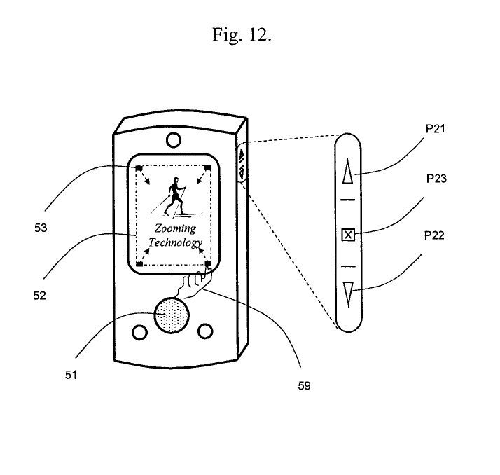

FIG. 12-14 shows zoom-out for a selected area according to the present invention.

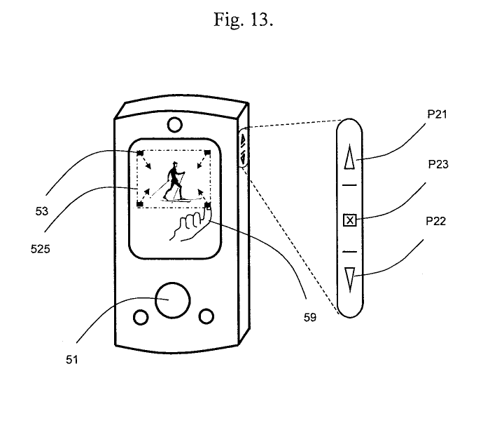

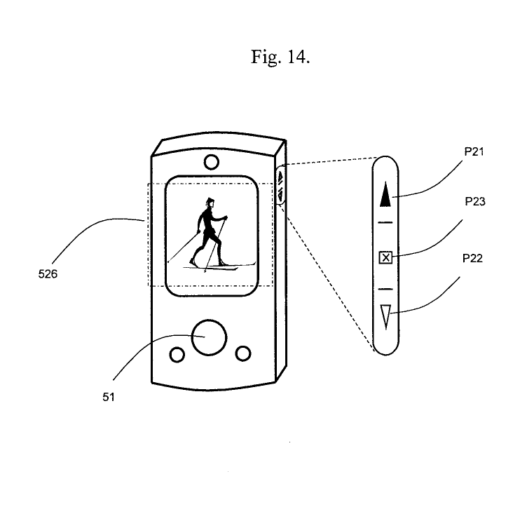

FIG. 12 shows when the zoom-mode button 51 is activated, a default zooming frame 52 appears on the display, which delimits full page information to be zoomed before it has been further specified by user. FIG. 13 shows only the skiing figure is delimited as the information to be zoomed. The information within the zooming frame 525 is then stored in the memory 32. FIG. 14 shows zoom-in according to the present invention. After the zooming frame 525 is determined in FIG. 13, zoom-in button P21 is pressed, the information in the zooming frame 525 is expanded, in proportion to the pressure applied, into a larger one as shown in FIG. 14, the expanded information within the zooming frame 526. The skiing figure of FIG. 14 is expanded to a larger one with reference to the skiing figure in FIG. 13. The physical closing box P23 can be pressed to close the zoom-mode.

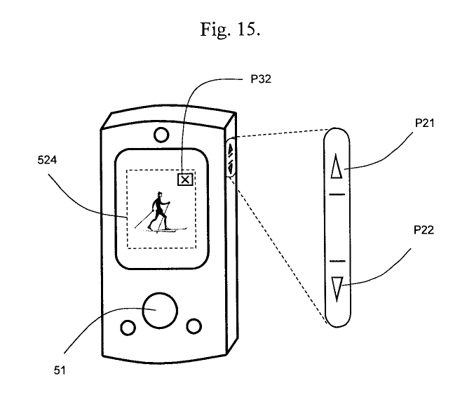

FIG. 15 is a virtual closing box for closing zoom-mode according to the present invention.

When the zoom-mode button 51 is pressed, a virtual closing box P32 for closing zoom-mode displays on the right top corner of the zooming frame 524. The virtual closing box P32 exists whenever the zooming frame is expanded or shrunk, the closing box P32 can be activated by a touch on the screen by a finger to close the zoom-mode.

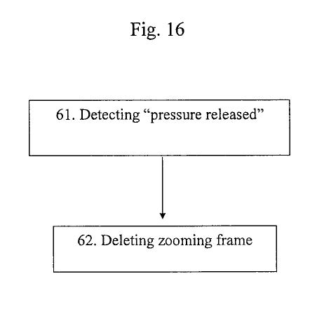

FIG. 16 is a first method for closing zoom-mode without using an independent button according to the present invention.

The method for closing a zoom-mode without using an independent button, includes:

61. Detecting “pressure released”; and

62. Deleting zooming frame.

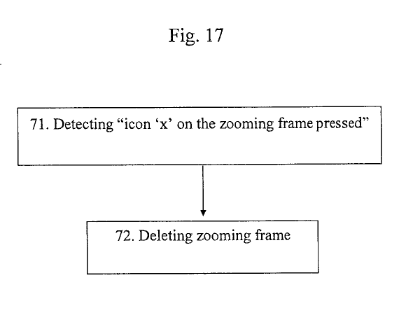

FIG. 17 is a second method for closing zoom-mode according to the present invention.

The method for closing a zoom-mode using a virtual button, includes:

71. Detecting “icon ‘x’ on the zoom-frame pressed”; and

72. Deleting zooming frame.

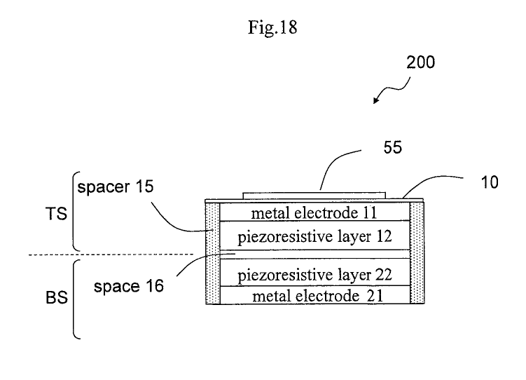

FIG. 18 is a modified pressure sensor according to the present invention.

A modified pressure sensor 200 is shown in FIG. 15, a piece of button 55 made of rubber, plastic, metal, or glass is configured on top of the top substrate 10. The button 55 occupies an area smaller than a top area of the metal electrode 11 to keep away from area above the spacer 15. The button 55 facilitates user to press the sensor underside. The harder piece of button 55 moves up and down with a fixed area A, this design is adapted to trigger a stable output signal from the pressure sensor with a fixed area A depressed, referring to ohm's law: R=ρL/A, when the area A is ideally fixed, the output resistance R is theoretically in positive proportion to the total thickness L of the compressed piezoresistive layers. In a practical device, both L and A change when pressure is applied.

While several embodiments have been described by way of example, it will be apparent to those skilled in the art that various modifications may be made without departing from the spirit of the present invention. Such modifications are all within the scope of the present invention, as defined by the appended claims.

What is claimed is:

1. A zooming system for a display, comprising:
a zooming circuit, operated according to a predetermined algorithm, for zooming information in a zooming frame; and
a zooming pressure sensor, electrically coupled to said zooming circuit and capable of converting a pressure input into a physical parameter detectable by said zooming circuit; wherein
a magnitude of said physical parameter is in proportion to a zoom factor of said zooming.

2. A zooming system as claimed in claim 1, wherein
said zooming frame is a default zooming frame.

3. A zooming system as claimed in claim 1, wherein
said zooming frame is a user-specified zooming frame.

4. A zooming system as claimed in claim 1, further comprises:
a memory, electrically coupled to said zooming circuit, for storing said information in said zooming frame for further process.

5. A zooming system as claimed in claim 1, wherein
said pressure sensor is selected from a group consisted of a piezoresistive pressure sensor, a capacitance-type pressure sensor, a strain gauge, and a piezoelectric sensors.

6. A zooming system as claimed in claim 1, wherein said physical parameter is selected from a group consisted of conductance, capacitance, and charge.

7. A zooming system as claimed in claim 1, wherein
said proportion is in positive relation.

8. A zooming system as claimed in claim 1, wherein
said proportion is in negative relation.

9. A zooming system as claimed in claim 1, wherein
said zooming circuit is configured for zoom-in function.

10. A zooming system as claimed in claim 1, wherein
said zooming circuit is configured for zoom-out function.

11. A zooming system as claimed in claim 1, wherein
said zooming circuit is configured for both zoom-in and zoom-out functions.

12. A zooming system as claimed in claim 9, further comprises:
a pressure button, configured on top of said pressure sensor, for triggering said zoom-in function.

13. A zooming system as claimed in claim 10, further comprises:
a pressure button, configured on top of said pressure sensor, for triggering said zoom-out function.

14. A zooming system as claimed in claim 12, further comprises:
a closing button, electrically coupled to said zooming circuit, for cancelling said zoom-in function.

15. A zooming system as claimed in claim 13, further comprises:
a closing button, electrically coupled to said zooming circuit, for cancelling said zoom-out function.

16. A zooming system as claimed in claim 12, wherein
said zoom-in mode is closed when said pressure button is released.

17. A zooming system as claimed in claim 13, wherein
said zoom-out mode is closed when said pressure button is released.

18. A zooming system as claimed in claim 14, wherein
said closing button is a physical button.

19. A zooming system as claimed in claim 14, wherein
said closing button is a virtual button on said display.

20. A zooming system as claimed in claim 15, wherein
said closing button is a physical button, made of rubber, plastic, or metal, or glass.

21. A zooming system as claimed in claim 15, wherein
said closing button is a virtual button on said display.

22. A zooming system as claimed in claim 16, wherein
said closing physical button is configured on bottom of said zoom-in pressure button.

23. A zooming system as claimed in claim 18, wherein
said closing physical button is configured on top of said zoom-out pressure button.

24. An algorithm for creating a zooming frame as claimed in claim 1, comprising:
(1) Activating zoom-mode;
(2) Creating a zooming frame;
(3) Setting zooming level according to a detected pressure; and
(4) Setting zooming frame size and/or position.

25. An algorithm for creating a zooming frame as claimed in claim 1, comprising:
(1) Activating zoom-mode;
(2) Creating a zooming frame;
(3) Setting zooming level according to a detected pressure;
(4) Detecting whether the zooming frame size and/or position has been further specified by user? and
if yes go next step,
if no, selecting default zooming frame size and/or position;
(5) Setting zooming frame size and/or position.

26. An algorithm for updating the zooming frame as claimed in claim 1, comprising:
(1) Detecting the pressure applied on the pressure button;
(2) Determining whether the pressure remains? and
if yes, updating zoom level;
if no, go next step
(3) Notifying system that the pressure is released.

27. A portable electronic device having a zooming system as claimed in claim 1, wherein said zooming pressure sensor is mounted on a side wall of device.

28. A portable electronic device having a zooming system as claimed in claim 1, wherein said zooming pressure sensor is mounted on a front side of said device.

29. A portable electronic device having a zooming system as claimed in claim 1, wherein said zooming pressure sensor is mounted on a backside of said device.

30. A portable electronic device having a zooming system as claimed in claim 1, wherein said information within said zooming frame changes with different zoom-level.
